(19) United States
(12) Patent Application Publication
(10) Pub. No.: US 2017/0214626 A1
(43) Pub. Date: Jul. 27, 2017

(54) APPLICATION BASED LINK SELECTION BASED ON LINK CHARACTERISTICS

(71) Applicant: RIVET NETWORKS LLC, Austin, TX (US)

(72) Inventors: WAYNE DUNLAP, Austin, TX (US); Charles Musta, Austin, TX (US)

(21) Appl. No.: 15/005,062

(22) Filed: Jan. 25, 2016

(51) Int. Cl. H04L 12/859; H04W 48/06; H04W 48/20

(52) U.S. Cl. CPC H04L 47/2475; H04W 48/20; H04W 48/06

(57) ABSTRACT

A computer device can establish multiple links with a network, with each link having different characteristics such as bandwidth, jitter, latency, and the like. The computer device can execute applications of different types, and can select for each application one of the links with the network based on both the type of application and the characteristics of the link. The computer device can thereby select the best link for each application, improving overall communication via the network.

### BACKGROUND

Field of the Disclosure

The present disclosure relates generally to computer networks and more particular to communication management with a computer network.

Description of the Related Art

Communication networks are employed to transfer a wide variety of information between electronic devices. However, as the amount of information transferred over a communication network increases, the communication backbone that governs the network can become stressed, causing undesirable delays in information transfer. This can result in a poor user experience. For example the user can experience network lag, where packets are held at a network node while awaiting transfer to another network node, for an amount of time such that the user is able to perceive the delay in the information transfer. Further, network lag and other network transfer problems can impact a wide variety of applications, such as gaming applications, voice communication applications, and the like.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a communication system including a computer device that communicates with a network over multiple links in accordance with at least one embodiment.

FIG. 2 is a block diagram illustrating the computer device of FIG. 1 in accordance with at least one embodiment.

FIG. 3 is a block diagram of a communication system including a computer device that communicates with a network over multiple links in accordance with at leapt one embodiment.

FIG. 4 is a flow diagram of a method of communicating with a network over different links depending on application traffic type and link characteristics in accordance with at least one embodiment.

FIG. 5 is a flow diagram of a method of communicating with a network over different access points depending on application traffic type and link characteristics in accordance with at least one embodiment.

### DETAILED DESCRIPTION

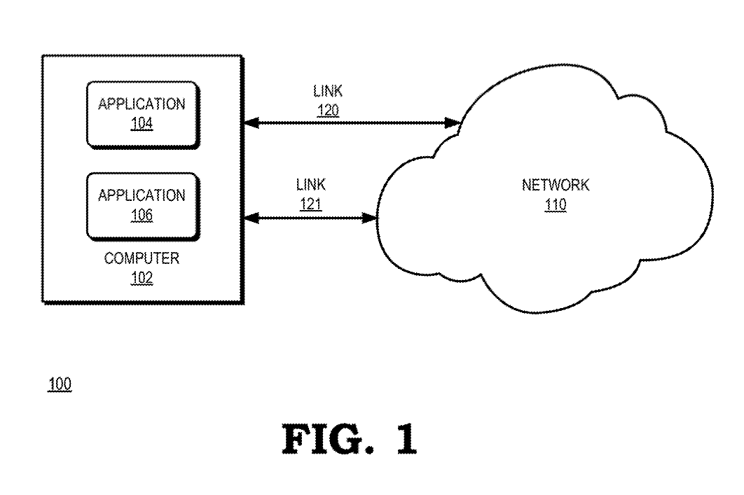

FIGS. 1-5 illustrate techniques for managing at a computer device communication of information with a network. The computer device can establish multiple links with the network, with each link having different characteristics such as bandwidth, jitter, latency, and the like. The computer device can execute applications of different types, and can select for each application one of the links with the network based on both the type of application and the characteristics of the link. The computer device can thereby select the best link for each application, improving overall communication via the network.

To illustrate via an example, some types of computer applications, such as voiceover Internet protocol (VOIP) applications, communicate more efficiently via links with low jitter, while other types of applications, such as a game patching application, communicate more efficiently over high-bandwidth links. Using the techniques described herein, the computer device can select the best link for each type of application, thus selecting the lowest-jitter link for the VOIP application and the highest-bandwidth link for the game patching application. The computer device thereby improves communication efficiency for both types of applications, and thus improves the overall user experience with the computer device.

FIG. 1 illustrates, a block diagram of a communication system 100 including a computer device 102 and a network 110. The network 110 can be a local area network (LAN), wide area network such as the Internet, or a combination thereof. The network 110 is composed of routers, switches, servers, and other devices to route messages between nodes so that the message reaches a destination indicated in the message. In at least one embodiment, the network 110 is a packet-switched network wherein the messages are composed of one or more packets, with the network 110 configured to route packets between network nodes based on address information in the packet headers.

The computer device 102 can be any computer device that is capable of communicating with a network, such as a desktop computer, laptop computer, server, tablet, smartphone, game console, and the like. The computer device 102 includes a processor (not shown) that executes instructions organized in the form of computer programs, referred to generally herein as applications. In the illustrated example of FIG. 1, the computer device 102 concurrently executes two computer programs, designated application 104 and application 106. The applications 104 and 106 can by any type of application, such as VOIP application, web browser, game application, game patching application, productivity application such as a word processor, and the like. In at least one embodiment, the applications 104 and 106 can be different functions of a single application, such as separate downloading and user-interaction functions of a game program.

The computer device 102 includes circuitry, such as a network interface card, network communication chip, and the like, to establish links with the network 110. In particular, the computer device 102 can concurrently maintain multiple links with the network 110. In the illustrated example of FIG. 1, the computer device 102 maintains links 120 and 121, but it will be appreciated that in other embodiments the computer device 102 can establish and concurrently maintain more than two links with the network 110. The links 120 and 121 can each employ different communication media; for example, the link 120 can be a wired network link and the link 120 can be a wireless network link. In other embodiments, the links 120 and 121 can employ the same communication media but with different communication parameters. For example, the link 120 can be a wireless link communicating via one wireless frequency and the link 121 can be a wireless link communicating via a different wireless frequency.

The computer device 102 is configured to communicate (send and receive) packets via both of the links 120 and 121. The computer device 102 can employ both of the links 120 and 121 concurrently. That is, the computer device 102 can send and receive packets via the links 120 and 121 concurrently. Further, the computer device 102 can use the links 120 and 121 for different applications. For example, the computer device 102 can send and receive packets for the application 104 via link 120 and send and receive packets for the application 106 via the link 121. The links 120 and 121 are selectable, such that the computer device 102 can select any link for any application, and can change the link selected for an application over time.

In at least one embodiment, the computer device 102 can select the link for an application based on both the type of application and characteristics of the link. In particular, the computer device 102 can analyze each link to identify link characteristics, also referred as link metrics, for each of the links 120 and 121. Examples of link metrics include jitter, bandwidth, latency, reliability, congestion, environmental noise and the like. The link metrics can be identified based on any of a number of factors, including packet acknowledgement response time, packet payload information, signal-to-noise ratio (SNR), retransmission rate, collision rate, number of transmission backoffs, link speed, channel width, and the like, or a combination thereof. In at least one embodiment, the computer device 102 identifies the link metrics by analyzing packets sent and received over the link. The computer device 102 may also, in conjunction with the packet analysis, sense electrical characteristics, such as SNR, of the link using detection circuitry. The computer device 102 can also determine a type of each application based on a list of application types and application identifiers, based on information provided by the application itself, based on packet analysis (e.g., destination address of packets generated by the application), and the like.

Based on the type of application, the computer device 102 selects a link to communicate (send and receive) traffic for that application. In particular, based on a predefined or programmable list (not shown) of application types and link metrics, the computer device 102 selects for an application the link indicated by the list. For example, if the list indicates that a particular type of application should be assigned to a low-jitter link, the computer device 102 selects for the application the lowest-jitter link as indicated by the link metrics.

To illustrate via an example, in at least one embodiment the computer device 102 identifies the link 121 as a link having relatively low jitter and low bandwidth and the link 122 as having relatively high bandwidth and high jitter. In addition, the computer device 102 identifies that the application 104 is of a type that benefits more from a low-jitter link and the application 106 is of a type that benefits from a high-bandwidth link. Accordingly, the computer device 102 selects the link 121 for the application 104 and the link 122 for the application 106, and communicates the packets for each application via the selected link.

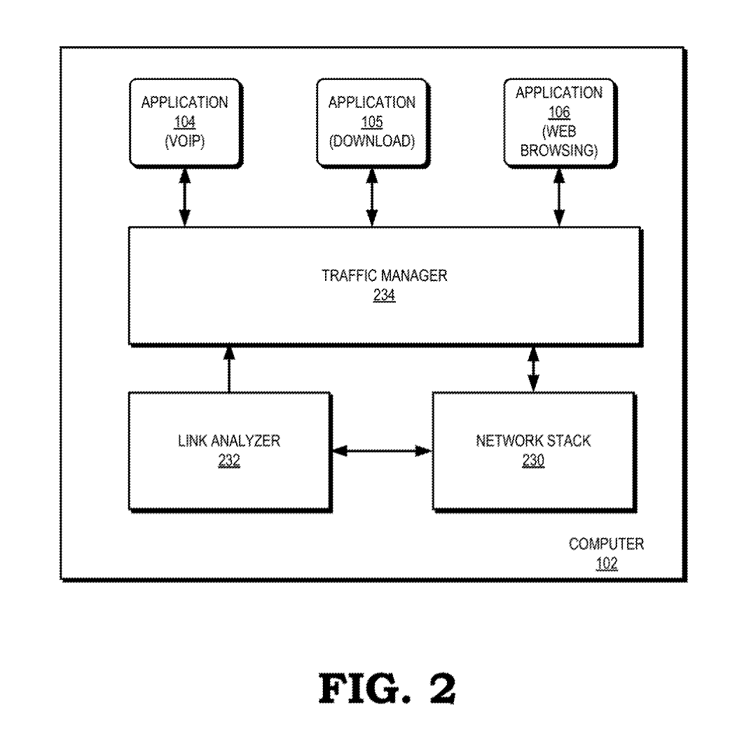

FIG. 2 illustrates a block diagram of the computer device 102 in accordance with some embodiments. In the illustrated example, the computer device 102 includes a network stack 230, a link analyzer 232, and a traffic manager 234. The network stack 230 is a set of one or more hardware or software modules, or a combination thereof that communicates (sends and receives) packets via the links 121 and 122. In at least one embodiment, the network stack 230 handles all of the physical (PHY) and logical layer functions of a network protocol stack for communication of the packets.

The link analyzer 232 is a set of one or more hardware or software modules, or a combination thereof that identifies link metrics for each of the links 121 and 122. Accordingly, the link analyzer 232 can analyze packets stored at the network stack 230 to identify link metrics, such as bandwidth and latency. In addition, the link analyzer 232 can include circuits to identify electrical characteristics of the links 121 and 122, such as signal to noise ratio.

The traffic manager 234 is a set of one or more hardware or software modules, or a combination thereof, that identifies the type of each application that is being executed at the computer device 102 and the characteristics of each link available to the network stack 230. The traffic manager 234 is further configured to identify a link to be used to communicate packets for each of the applications being executed. The traffic manager 234 can identify the link by modifying header information in a. packet, by providing control signaling to the network stack 230, and the like.

To illustrate, in the example of FIG. 2 the computer device 102 executes applications 104-106, with each application being of a different type. In particular, the application 104 is a VOIP application, the application 105 is an application directed to downloading programs or other files from the network 110, and the application 106 is a web browsing application. The traffic manager 234 identifies the type of each of the applications 104-106 based on information provided by the applications themselves (e.g. a message including an application-type designator), based on predefined or programmable list, of applications and corresponding types, based on analysis of packets generated by the applications, and the like, or a combination thereof. The application type can also indicate the link metrics preferred by the type of application, such as bandwidth level, jitter level, latency, and the like, or a combination thereof. The traffic manager 234 also receives link metric information from the link analyzer 232 indicating the link metrics for the links 120 and 121.

Based on the link metrics and application type, the traffic manager 234 selects one of the links 120 and 121 for the application. In response to receiving a packet from an application, the traffic manager identifies the link selected fur that application, and instructs the network stack 230 to communicate the packet via the selected link.

In at least one embodiment, an application may generate communication traffic of different types, and the traffic manager 234 can individually select links for each type of traffic generated by an application. For example, a game application may generate real-time game packets and may also generate packets related to downloading a game patch. The traffic manager 234 can select different links for each type of packet, such as selecting a high-bandwidth link for the packets related to downloading the game patch and a low-latency link for the packets related to real-time gaming.

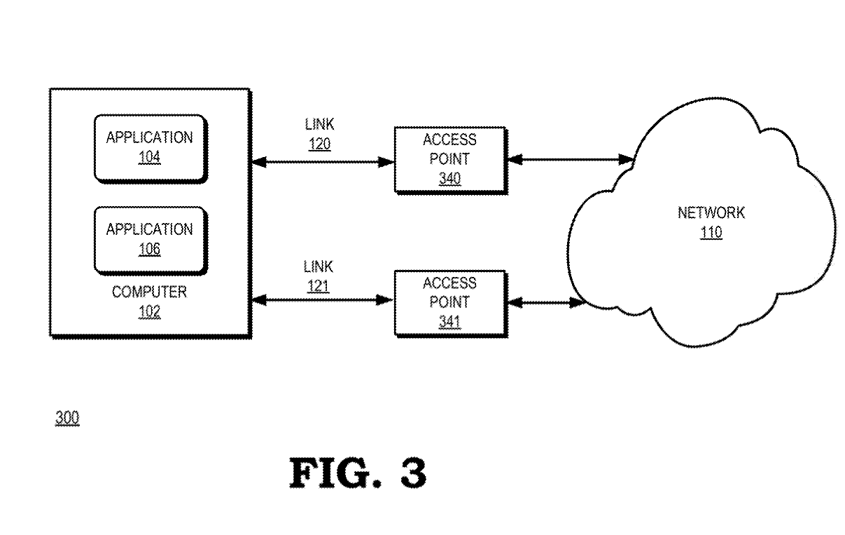

In at least one embodiment, each of the links 120 and 121 may be associated with a different access point to the network 110. An example is illustrated at FIG. 3, which depicts a communication system 300 including the computer device 102 and the network 110. In the depicted example, the link 120 to the network 110 is maintained via an access point 340 and the link 121 is maintained via an access point 341. In at least one embodiment the access points 340 and 341 are different wireless access points, such as different routers, different cellular towers, and the like. The links 120 and 121 are maintained simultaneously, so that the computer device 102 is connected to the network 110 via both of the access points 340 and 341 simultaneously. The computer device 102 can select which link, and therefore which of the access points 340 and 341 to use for each application based on link metrics and application types, in similar fashion to that described above with respect to FIG. 1.

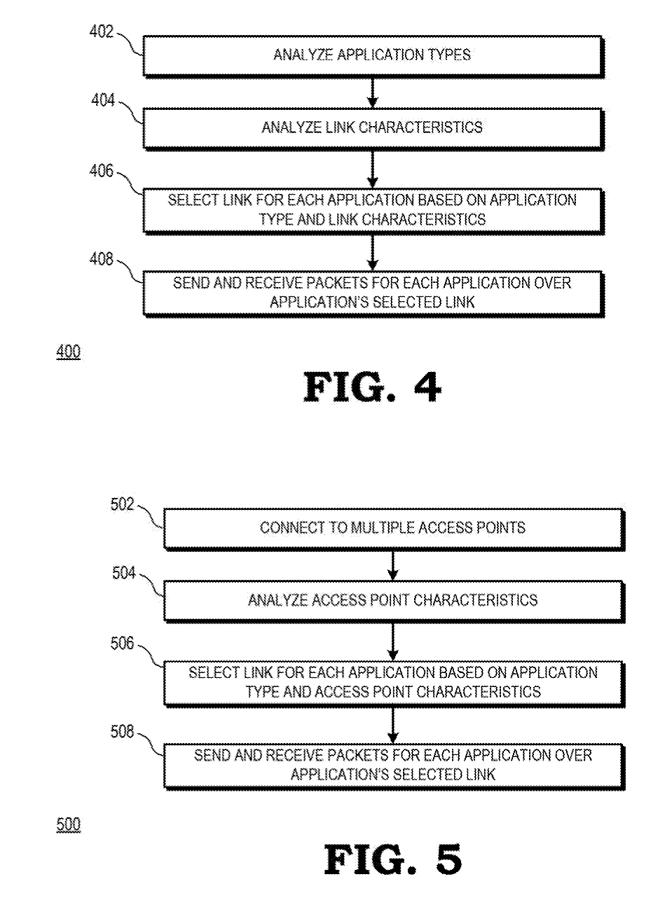

FIG. 4 is a flow diagram of a method 400 of communicating packets at a computer device via different links in accordance with at least one embodiment of the present disclosure. The method 400 is described with respect to an example implementation at the communication system 100 of FIG. 1 and the computer device 102 of FIG. 2. At block 402 the traffic manager 234 analyzes the applications being executed at the computer device 102 to identify a type for each application. At block 404 the link analyzer 232 identifies link metrics for each of the links to the network 110 established by the computer device 102. At block 406 the traffic manager 234 selects, for each executing application, one of the links 120 and 121 based on the link metrics identified at block 404 and the application types identified at block 408. At block 408 the traffic manager 234 communicates packets for each application via the corresponding link selected for that application. Because the links have been selected according to the link metrics, overall network communication efficiency for the computer device 102 is enhanced.

FIG. 5 is a flow diagram of a method 500 of communicating packets at a computer device via different network access points in accordance with at least one embodiment of the present disclosure. The method 500 is described with respect to an example implementation at the communication system 300 of FIG. 3 and the computer device 102 of FIG. 2. At block 502 the computer device 102 establishes multiple links to the network 110, with each link established via a different access point for the network 110. At block 504 the link analyzer 232 identifies link metrics for each of the access points and corresponding links to the network 110, At block 506 the traffic manager 234 selects, for each executing application, one of the links 120 and 121 based on the link metrics and the type of applications. At block 408 the traffic manager 234 communicates packets for each application via the corresponding link, and the access point corresponding to the link, as selected for that application.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network. (e.g., network accessible storage (NAS)).

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying at a computer device, for each of a plurality of communication links to a network, a first link metric;
identifying, for a first application executing at the computer device, a corresponding first application type; and
communicating packets, for the first application via a first link of the plurality of communication links, the first link selected based on the first application type and the first link metric.

2. The method of claim 1, further comprising:
identifying, for a second application executing at the computer device, a corresponding second application type; and
communicating packets for the first application via a second link of the plurality of communication links, the second link selected based on the second application type and the first link metric.

3. The method of claim 2, further comprising
identifying at the, computer device for each of the plurality of communication links a second link metric; and
wherein the first link and the second link are each selected based on the first link metric and the second link metric.

4. The method of claim 3, wherein the first link metric comprises a metric of a first type and the second link metric comprises a metric of second type different than the first type.

5. The method of claim 1, wherein:
identifying the first application type comprises identifying a first function type for a first function of the first application and identifying a second function type for a second function of the first application; and
wherein communicating packets for the first application comprises communicating a first set of packets associated with the first function via the first link and communicating a second set of packets associated with the second function via a second link of the plurality of links, the second link selected based on the second function type.

6. The method of claim 1, wherein the first link metric is one of a jitter metric, bandwidth metric, latency metric, reliability metric, congestion metric, and environmental noise metric.

7. The method of claim 1, wherein identifying the first link metric comprises identifying the first link metric based on at least one of a packet acknowledgement response time, packet payload information, signal-to-noise ratio (SNR), retransmission rate, collision rate, number of transmission backoffs, link speed, and channel width.

8. The method of claim 1, wherein each of the plurality of communication links includes a different access point to a network.

9. A method comprising:
maintaining at a computer device a first link to a first access point of a network;
maintaining at the computer device, concurrent with the first link, a second link to a second access point of the network;
identifying link metrics for the first link and the second link; and
selecting one of the first link and the second link to communicate packets for a first application executing at the computer device based on the link metrics and an application type of the first application.

10. The method of claim 9, wherein the first access point is a first wireless access point and the second access point is a second wireless access point different from the first wireless access point.

11. The method of claim 9, wherein the link metrics include one of a jitter metric, bandwidth metric, latency metric, reliability metric, congestion metric, and environmental noise metric.

12. The method of claim 9, wherein identifying the link metrics comprises identifying the link metrics based on at least one of a packet acknowledgement response time, packet payload information, signal-to-noise ratio (SNR), retransmission rate, collision rate, number of transmission backoffs, link speed, and channel width.

13. A non-transitory computer readable medium embodying a set of executable instructions, the set of executable instructions to manipulate at least one processor to:
identify at a computer device, for each of a plurality of communication links to a network, a first link metric;
identify, for a first application executing at the computer device, a corresponding first application type; and
communicate packets for the first application via a first link of the plurality of communication links, the first link selected based on the first application type and the first link metric.

14. The computer readable medium of claim 13, further comprising instructions to:
identify, for a second application executing at the computer device, a corresponding second application type; and
communicate packets for the first application via a second link of the plurality of communication links, the second link selected based on the second application type and the first link metric.

15. The computer readable medium of claim 14, further instructions to:
identify at the computer device for each of the plurality of communication links a second link metric; and
wherein the first link and the second link are each selected based on the first link metric and the second link metric.

16. The computer readable medium of claim 15, wherein the first link metric comprises a metric of a first type and the second link metric comprises a metric of second type different than the first type.

17. The computer readable medium of claim 13, wherein;
the instructions to identify the first application type comprise instructions to identify a first function type for a first function of the first application and identifying a second function type for a second function of the first application; and
wherein the instructions to communicate packets for the first application comprise instructions to communicate a first set of packets associated with the first function via the first link and to communicate a second set of packets associated with the second function via a second link of the plurality of links, the second, link selected based on the second function type.

18. The computer readable medium of claim 13, wherein the first link metric is one of a jitter metric, bandwidth metric, latency metric, reliability metric, congestion metric, and environmental noise metric.

19. The computer readable medium of claim 13, wherein identifying the first link metric comprises identifying the first link metric based on at least one of a packet acknowledgement response time, packet payload information, signal-to-noise ratio (SNR), retransmission rate, collision rate, number of transmission backoffs, link speed, and channel width.

20. The computer readable medium of claim 13, wherein each of the plurality of communication links includes a different access point to a network.
